(19) United States
(12) Patent Application Publication
(10) Pub. No.: US 2015/0326150 A1
(43) Pub. Date: Nov. 12, 2015

(54) MAGLEV WORKPIECE TABLE WITH SIX DEGREES OF FREEDOM

(71) Applicant: TSINGHUA UNIVERSITY, Beijing (CN)

(72) Inventors: Yu ZHU, Beijing (CN); Ming ZHANG, Beijing (CN); Yujing SONG, Beijing (CN); Rong CHENG, Beijing (CN); Hao LIU, Beijing (CN); Zhao LIU, Beijing (CN); Kaiming YANG, Beijing (CN); Jinchun HU, Beijing (CN); Dengfeng XU, Beijing (CN); Wensheng YIN, Beijing (CN); Haihua MU, Beijing (CN)

(21) Appl. No.: 14/652,072

(22) PCT Filed: Dec. 6, 2013
(86) PCT No.: PCT/CN2013/088726

§ 371 Date: Jun. 12, 2015

(30) Foreign Application Priority Data
Dec. 12, 2012 (CN) 201210535413.0

(51) Int. Cl. H02N 15/00; B23Q 3/15

(52) U.S. Cl. CPC H02N 15/00; B23Q 3/15

(57) ABSTRACT

A maglev working table with six degrees of freedom comprises a pedestal (800), a rotation drive apparatus, a planar-motion apparatus, an angle measuring apparatus (500), and a displacement measuring apparatus. The displacement measuring apparatus comprises four direct-current motors (600) and four displacement measuring apparatus PSD assemblies. Under the effect of the rotation drive apparatus, a planar-motion apparatus coil array stator (200) axially connected to a rotation drive apparatus circular permanent-magnet array mover (300) rotates, so that a phase difference is formed between a planar-motion apparatus permanent-magnet array mover (100) and the planar-motion apparatus coil array stator, and then the maglev working table mover, namely, the planar-motion apparatus permanent-magnet array mover rotates at 360° in the horizontal plane. Moreover, the planar-motion apparatus permanent-magnet array mover moves horizontally within a large scope under the effect of the lorentz force, and can further move around the X axis, the Y axis, and the Z axis within a small scope, so that the maglev working table can move at six degrees of freedom.

### FIELD OF THE INVENTION

The present invention relates to a maglev workpiece table with six degrees of freedom in the manufacturing process of semiconductors.

### BACKGROUND OF THE INVENTION

In a conventional workpiece table, a series type structure is applied to perform a planar movement and a rotation of 360° of a moving platform, i.e., two or more linear motors are superimposed in structure to perform a planar movement of the moving platform, and two direct drive motors which can perform a rotation of 360° are added in series to the planar movement driving structure composed of the two or more linear motors, thus achieving the planar movement and the rotation of the moving platform at the same time. However, the above series type structure is complicated and occupies too much room, and moreover, errors can accumulate in the forming of such superimposed structure, thus having a negative influence on the precision of the workpiece table.

### SUMMARY OF THE INVENTION

The present invention provides a magslev workpiece table with six degrees of freedom, which can perform a rotation of 360° and a planar movement in a relatively large extent, aiming at reducing the floor space occupied, reducing the error in transmission and improve the precision of movement.

The technical solution of the present invention is as follows.

A maglev workpiece table with six degrees of freedom is provided, comprising a pedestal, a rotation driving device, a planar movement driving device, an angle measuring device and a displacement measuring device. The rotation driving device comprises an annular stator of coil array of the rotation driving device and an annular rotor of permanent magnet array of the rotation driving device. The planar movement driving device comprises a stator of coil array of the planar movement driving device, a rotor of permanent magnet array of the planar movement driving device, and linear motors. The annular stator of coil array of the rotation driving device is fixed on the pedestal. The annular rotor of permanent magnet array of the rotation driving device is coaxially suspending above the annular stator of coil array of the rotation driving device. The stator of coil array of the planar movement driving device is shaft coupled to the annular rotor of permanent magnet array of the rotation driving device. The rotor of permanent magnet array of the planar movement driving device is suspending above the stator of coil array of the planar movement driving device under magnetic suspension. The angle measuring device is positioned on the annular rotor of permanent magnet array of the rotation driving device. The displacement measuring device includes PSD assemblies which include receiving devices and transmitting devices, wherein the receiving devices are symmetrically fixed on the linear motors around the stator of coil array of the planar movement driving device, and the transmitting devices are symmetrically fixed around the rotor of permanent magnet array of the planar movement driving device.

When the stator of coil array of the planar movement driving device is energized, a lorenthz force is generated between the stator of coil array of the planar movement driving device and the rotor of permanent magnet array of the planar movement driving device, such that the rotor of permanent magnet array of the planar movement driving device generates pushing forces in the directions of an X axis, a Y axis and a Z axis, wherein the pushing forces along the X-axis and Y-axis directions in the horizontal plane enable the rotor of permanent magnet array of the planar movement driving device to perform a planar movement in the X-Y plane and a rotation of a relatively small angle around the Z axis, the pushing force in the direction of the Z axis enables the suspension of the rotor of permanent magnet array of the planar movement driving device, and a differential between the pushing forces of the Z-axis direction enables the rotor of permanent magnet array of the planar movement driving device to rotate around the X and Y axes with a relatively small angle, thus achieving the movement of six degrees of freedom of the rotor of permanent magnet array of the planar movement driving device; a torque due to lorenthz force is generated between the annular stator of coil array of the rotation driving device and the annular rotor of permanent magnet array of the rotation driving device, enabling the annular rotor of permanent magnet array of the rotation driving device to perform a rotation of 360°, and further enabling the stator of coil array of the planar movement driving device to perform a rotation of 360°, such that under the lorenthz force and the torque, the rotor of permanent magnet array of the planar movement driving device can perform a rotation of 360° around the Z axis.

Further, in the rotation driving device, the permanent magnets of the annular rotor of permanent magnet array of the rotation driving device and the coils of the annular stator of coil array of the rotation driving device are all in the shape of rectangle, sector or trapezoid, and in the planar movement driving device, the stator of coil array of the planar movement driving device is in a form of superimposed layers, wherein the adjacent two layers of coil array are in vertical directions with respect to each other.

In comparison with the prior art, the present invention has the following advantages. The workpiece table can perform a rotation of a relatively large range as 360° around the Z axis while in a planar movement of a relatively large range; the present invention has simplified structure which takes less floor space under the same conditions; the transmission error is reduced in comparison with the conventional structure; a higher precision and even a nanoscale precision can be achieved with the magnetic suspension technique and effective control thereof.

### BRIEF DESCRIPTION OF THE DRAWINGS

FIG. 1 is an isometric view showing the maglev workpiece table with six degrees of freedom according to the present invention.

FIG. 2 is a top view showing the rotor of permanent magnet array of the planar movement driving device according to the present invention.

FIG. 3 is an isometric view showing the stator of coil array of the planar movement driving device according to the present invention.

FIG. 4 is a front view showing the planar movement driving device and the displacement measuring device according to the present invention.

FIG. 5 is a force diagram of the rotor of permanent magnet array of the planar movement driving device according to the present invention.

FIG. 6 is a force diagram of a single permanent magnet array of the planar movement driving device according to the present invention.

Wherein:
100—rotor of permanent magnet array of planar movement drying device;
101—first permanent magnet array;
102—second permanent magnet array;
103—third permanent magnet array;
104—fourth permanent magnet array;
200—stator of coil array of planar movement driving device;
201—first layer of coil array;
202—second layer of coil array;
300—annular rotor of permanent magnet array of rotation driving device;
400—annular stator of coil array of rotation driving device;
500—angle measuring device;
600—linear motors;
601—first linear motor;
602—second linear motor;
603—third linear motor;
604—fourth linear motor;
700—PSD assemblies for displacement measurement;
701—first PSD receiving device;
702—second PSD receiving device;
703—third PSD receiving device;
704—fourth PSD receiving device;
705—first PSD transmitting device;
706—second PSD transmitting device;
707—third PSD transmitting device;
708—fourth PSD transmitting device;
800—pedestal.

### DESCRIPTION OF THE PREFERRED EMBODIMENT

The structure, principle and operating process of the present invention are further explained in detail in connection with the accompanying drawings.

The present invention provides a maglev workpiece table with six degrees of freedom, comprising a pedestal 800, a rotation driving device, a planar movement driving device, an angle measuring device and a displacement measuring device. The rotation driving device comprises an annular stator 400 of coil array of the rotation driving device and an annular rotor 300 of permanent magnet array of the rotation driving device. The planar movement driving device comprises a stator 200 of coil array of the planar movement driving device, a rotor 100 of permanent magnet array of the planar movement driving device, and linear motors 600. The annular stator of coil array of the rotation driving device is fixed on the pedestal. The annular rotor of permanent magnet array of the rotation driving device is coaxially suspending above the annular stator of coil array of the rotation driving device. The stator of coil array of the planar movement driving device is shaft coupled to the annular rotor of permanent magnet array of the rotation driving device. The rotor of permanent magnet array of the planar movement driving device is suspending above the stator of coil array of the planar movement driving device under magnetic suspension. The angle measuring device 500 is positioned on the annular rotor of permanent magnet array of the rotation driving device. The displacement measuring device include PSD assemblies which includes receiving devices and transmitting devices, wherein the receiving devices are symmetrically fixed on the linear motors around the stator of coil array of the planar movement driving device, and the transmitting devices are symmetrically fixed around the rotor of permanent magnet array of the planar movement driving device.

The rotation driving device includes an annular stator of coil array of the rotation driving device and an annular rotor of permanent magnet array of the rotation driving device. The annular stator of coil array of the rotation driving device is positioned on the pedestal. When the coil array is energized, a lorenthz force is generated between the annular stator of coil array of the rotation driving device and the annular rotor of permanent magnet array of the rotation driving device, providing a torque to enable the annular rotor of permanent magnet array of the rotation driving device to perform a rotation of 360°.

The planar movement driving device is positioned on the annular rotor of permanent magnet array of the rotation driving device, the planar movement driving device including a stator of coil array of the planar movement drying device and a rotor of permanent magnet array of the planar movement driving device. When the stator of coil array of the planar movement driving device is energized, a lorenthz force is generated between the stator of coil array of the planar movement driving device and the rotor of permanent magnet array of the planar movement driving device, such that the rotor of permanent magnet array of the planar movement driving device generates pushing forces in the directions of an X axis, a Y axis and a Z axis, wherein the pushing forces along the X-axis and Y-axis directions in the horizontal plane enable the rotor of permanent magnet array of the planar movement driving device to perform a planar movement in the X-Y plane and a rotation of a relatively small angle around the Z axis, the pushing force in the direction of the Z axis enables the suspension of the rotor of permanent magnet array of the planar movement driving device, and a differential between the pushing forces of the Z-axis direction enables the rotor of permanent magnet array of the planar movement driving device to rotate around the X and Y axes with a relatively small angle, thus achieving the movement of six degrees of freedom of the rotor of permanent magnet array of the planar movement driving device. The stator of coil array of the planar movement driving device is positioned above and shaft coupled to the annular rotor of permanent magnet array of the rotation driving device, thereby under the driving of the annular rotor of permanent magnet array of the rotation driving device, the stator of coil array of the planar movement driving device performs a rotation of 360°, enabling the rotor of permanent magnet array of the planar movement driving device to rotate by 360° around the Z axis under a lorenthz force and torque.

The angle measuring device is positioned on the rotation driving device, in such a way that, when the annular rotor of permanent magnet array of the rotation driving device performs a rotation, its angle of rotation can be measured.

The displacement measuring device is positioned on the planar movement driving device, and four linear motors are positioned around the stator of coil array of the planar movement driving device. Four PSD receiving devices are positioned on the four linear motors respectively, and four PSD transmitting devices are positioned around the rotor of permanent magnet array of the planar movement driving device and correspond to the four PSD receiving devices respectively.

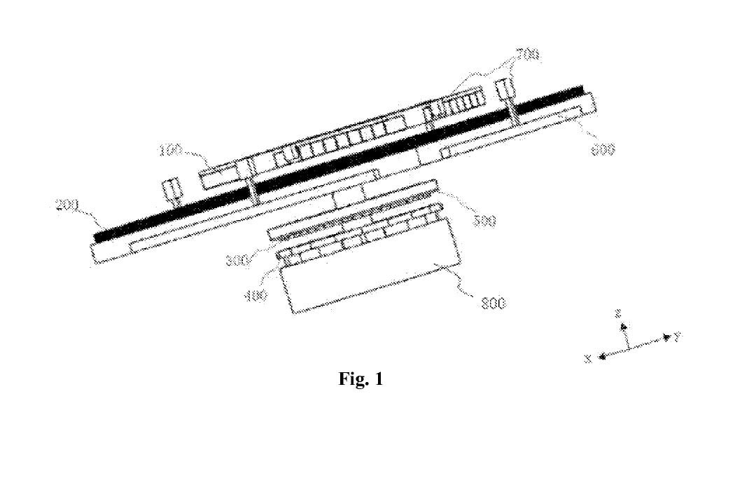

FIG. 1 is an isometric view showing the maglev workpiece table with six degrees of freedom. Under the effect of a lorentz force, the annular rotor 300 of permanent magnet array of the rotation driving device has a torque and rotates with respect to the annular stator 400 of coil array of the rotation driving device. As the annular rotor 300 of permanent magnet array of the rotation driving device and the stator 200 of coil array of the planar movement driving device are shaft coupled integrally, the stator 200 of coil array of the planar movement driving device rotates as the annular rotor 300 of permanent magnet array of the rotation driving device rotates. When the stator of coil array of the planar movement driving device is energized, a lorenthz force is generated between the stator 200 of coil array of the planar movement driving device and the rotor 100 of permanent magnet array of the planar movement driving device, such that the rotor 100 of permanent magnet array of the planar movement driving device generates pushing forces in the directions of an X axis, a Y axis and a Z axis, wherein the pushing forces along the X-axis and Y-axis directions in the horizontal plane enable the rotor 100 of permanent magnet array of the planar movement driving device to perform a planar movement in the X-Y plane and a rotation of a relatively small angle around the Z axis, the pushing force in the direction of the Z axis enables the suspension of the rotor 100 of permanent magnet array of the planar movement driving device by offsetting its gravity, and a differential between the pushing forces of the Z-axis direction enables the rotor 100 of permanent magnet array of the planar movement driving device to rotate around the X and Y axes with a relatively small angle. When the stator 200 of coil array of the planar movement driving device rotates, a phase difference and thus a torque is generated between the stator 200 of coil array of the planar movement driving device and the rotor 100 of permanent magnet array of the planar movement driving device, such that the rotor 100 of permanent magnet array of the planar movement driving device can perform a rotation of 360° with respect to the stator 200 of coil array of the planar movement driving device, enabling the rotor 100 of permanent magnet array of the planar movement driving device to rotate by any angle including 360° around the Z axis, thus achieving the movement of six degrees of freedom of the rotor 100 of permanent magnet array of the planar movement driving device.

The angle measuring device 500 is configured to perform an angle measurement on the annular rotor 300 of permanent magnet array of the rotation driving device. The displacement measuring device includes PSD assemblies including receiving devices and transmitting devices, wherein the receiving devices are symmetrically fixed on the linear motors 600 around the stator 200 of coil array of the planar movement driving device, and the transmitting devices are symmetrically fixed around the rotor 100 of permanent magnet array of the planar movement driving device, thus enabling the measurement for displacement of six degrees of freedom of the planar movement driving device.

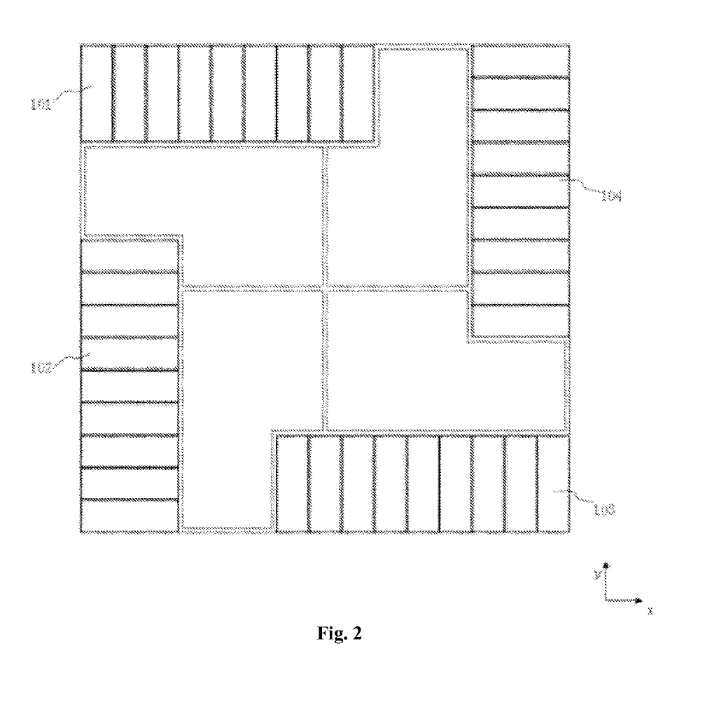

FIG. 2 is a top view showing the rotor 100 of permanent magnet array of the planar movement driving device, comprising four HALBACH permanent magnet arrays, i.e., a first permanent magnet array 101, a second permanent magnet array 102, a third permanent magnet array 103 and a fourth permanent magnet array 104. The first permanent magnet array 101 and the third permanent magnet array 103 are arranged in the X-axis direction while the second permanent magnet array 102 and the fourth permanent magnet array 104 are arranged in the Y-axis direction. When the coils are energized, the first permanent magnet array 101 and the third permanent magnet array 103 generate forces in the X-axis and Z-axis directions while the second permanent magnet array 102 and the fourth permanent magnet array 104 generate forces in the Y-axis and Z-axis directions, enabling the planar movement of the X-axis and Y-axis directions and suspension in the Z-axis direction of the rotor 100 of permanent magnet array of the planar movement driving device. Further, a differential between the push forces can generate a torque around the Z axis and torques around the X and Y axes, thus the movement of six degrees of freedom can be achieved for the rotor 100 of permanent magnet array of the planar movement driving device.

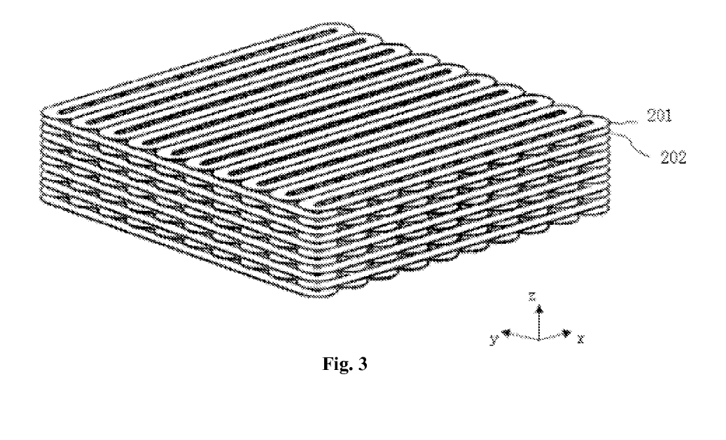

FIG. 3 is an isometric view showing the stator 200 of coil array of the planar movement driving device. The stator 200 of coil array of the planar movement driving device is formed of coil arrays which are superimposed vertically from each other, for example, the orientation of a first layer 201 of coil array has an angle difference of 90° from that of the second layer 202 of coil array. The coils of the first layer 201 of coil array are connected and fixed along the Y-axis direction, and the coils of the second layer 202 of coil array are fixed together along the X-axis direction. The third layer of coil array is arranged in the same way as that of the first layer of coil array, and the fourth layer of coil array is arranged in the same way as that of the second layer of coil array, other layers are arranged in a similar way as above, and so on. The number of layers of coil array can be determined depending on the actual requirement. The stator 200 of coil array of the planar movement driving device can provide lorentz forces in X-axis, Y-axis and Z-axis directions respectively for the rotor 100 of permanent magnet array of the planar movement driving device.

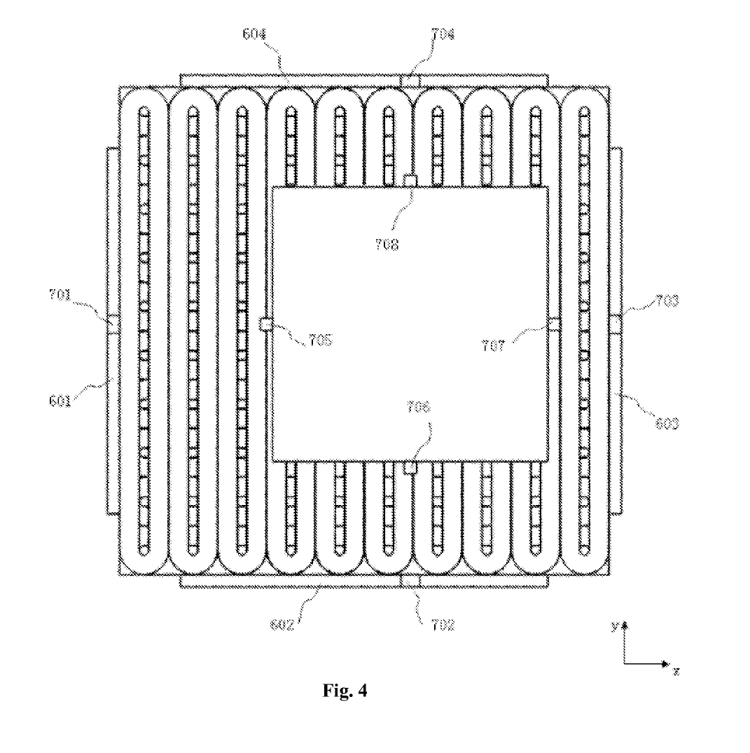

FIG. 4 is a front view showing the planar movement driving device and the displacement measuring device. The displacement measuring device is configured to measuring the displacement and angle of rotation of the rotor 100 of permanent magnet array of the planar movement driving device with respect to the stator 200 of coil array of the planar movement driving device. A first PSD receiving device 701, a second PSD receiving device 702, a third PSD receiving device 703 and a fourth PSD receiving device 704 of the displacement measuring device are symmetrically fixed on a first linear motor 601, a second linear motor 602, a third linear motor 603 and a fourth linear motor 604 around the stator 200 of coil array of the planar movement driving device, respectively. A first PSD transmitting device 705, a second PSD transmitting device 706, a third PSD transmitting device 707 and a fourth PSD transmitting device 708 are symmetrically positioned around the rotor 100 of permanent magnet array of the planar movement driving device. Wherein the first PSD receiving device 701 and the first PSD transmitting device 705 forms a pair, the second PSD receiving device 702 and the second PSD transmitting device 706 forms a pair, the third PSD receiving device 703 and the third PSD transmitting device 707 forms a pair, and the fourth PSD receiving device 704 and the fourth PSD transmitting device 708 forms a pair. When the rotor 100 of permanent magnet array of the planar movement driving device is moving, offsets occur for the projections of rays transmitted from the first PSD transmitting device 705, the second PSD transmitting device 706, the third PSD transmitting device 707 and the fourth PSD transmitting device 708 on the first PSD receiving device 701, the second PSD receiving device 702, the third PSD receiving device 703 and the fourth PSD receiving device 704, respectively, such that the planar movement and the rotation of the rotor 100 of permanent magnet array of the planar movement driving device can be obtained through calculations.

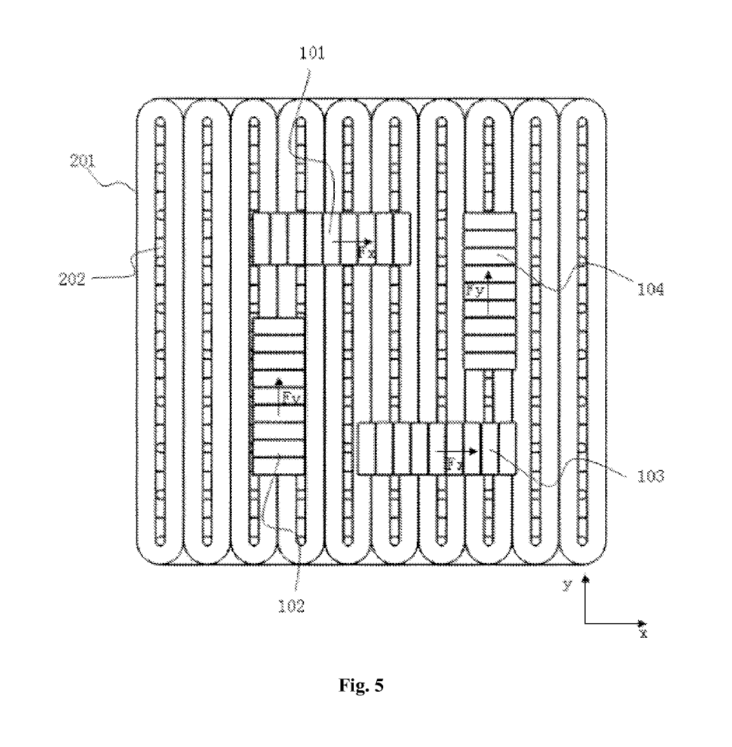

FIG. 5 is a force diagram of the rotor of permanent magnet array of the planar movement driving device according to the present invention. The rotor of permanent magnet array of the planar movement driving device consists of four HALBACH permanent magnet arrays, namely, the first permanent magnet array 101, the second permanent magnet array 102, the third permanent magnet array 103 and the fourth permanent magnet array 104. The first permanent magnet array 101 and the third permanent magnet array 103 are arranged along the X-axis direction, while the second permanent magnet array 102 and the fourth permanent magnet array 104 are arranged along the Y-axis direction. When the first layer 201 of coil array is energized, the first permanent magnet array 101 and the third permanent magnet array 103 generate forces in X-axis and Z-axis directions, while the second permanent magnet array 102 and the fourth permanent magnet array 104 do not generate any force. When the second layer 202 of coil array is energized, the first permanent magnet array 101 and the third permanent magnet array 103 do not generate any force, while the second permanent magnet array 102 and the fourth permanent magnet array 104 generate forces in Y-axis and Z-axis directions. In a similar way as above, when an odd-numbered layer of coil array is energized, the first permanent magnet array 101 and the third permanent magnet array 103 generate forces in the X-axis and Z-axis directions, which enable the rotor of permanent magnet array of the planar movement driving device to move in the X-axis and Z-axis directions. When the push forces in the Z-axis direction generated by the first permanent magnet array 101 and the third permanent magnet array 103 are different in magnitude, a torque around the X axis is generated, such that the rotor of permanent magnet array of the planar movement driving device can rotate about the X axis. When an even-numbered layer of coil array is energized, the second permanent magnet array 102 and the fourth permanent magnet array 104 generate forces in the Y-axis and Z-axis directions, which enable the rotor of permanent magnet array of the planar movement driving device to move in the Y-axis direction and the Z-axis direction. When the push forces in the Z-axis direction generated by the second permanent magnet array 102 and the fourth permanent magnet array 104 are different in magnitude, a torque about the Y axis is generated, such that the rotor of permanent magnet array of the planar movement driving device can rotate about the Y axis. When the stator of coil array of the planar movement driving device rotates, each of the four HALBACH permanent magnet arrays generates forces in the X-axis, Y-axis and Z-axis directions due to the phase difference between the stator of coil array of the planar movement driving device and the rotor of permanent magnet array of the planar movement driving device, such that the rotor of permanent magnet array of the planar movement driving device can rotate about the Z axis. Under the forces generated by the four permanent magnet arrays, the rotor of permanent magnet array of the planar movement driving device may generate a torque about the Z axis, move in the X-axis and Y-axis directions in a large range, rotate about the X axis and rotate about the Y axis and move in height direction, so that the rotor of permanent magnet array of the planar movement driving device can move with six degrees of freedom.

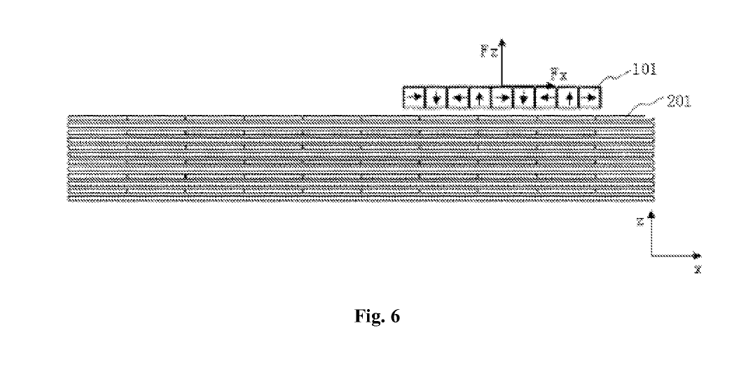

FIG. 6 is a force diagram of a single permanent magnet array of the rotor of permanent magnet array of the planar movement driving device according to the present invention. The first permanent magnet array 101 is arranged in the X-axis direction. The first layer 201 of coil array, i.e., the odd-numbered layer of coil array provides lorents forces Fx, Fz in the X-axis and Z-axis directions for the first permanent magnet array 101. Other permanent magnet arrays have a similar force condition.

1. A maglev workpiece table with six degrees of freedom is provided, comprising a pedestal (800), a rotation driving device, a planar movement driving device, an angle measuring device and a displacement measuring device; the rotation driving device comprises an annular stator (400) of coil array of the rotation driving device and an annular rotor (300) of permanent magnet array of the rotation driving device; the planar movement driving device comprises a stator (200) of coil array of the planar movement driving device, a rotor (100) of permanent magnet array of the planar movement driving device, and linear motors (600); the annular stator (400) of coil array of the rotation driving device is fixed on the pedestal (800), and the annular rotor (300) of permanent magnet array of the rotation driving device is coaxially suspending above the annular stator (400) of coil array of the rotation driving device; the stator (200) of coil array of the planar movement driving device is shaft coupled to the annular rotor (300) of permanent magnet array of the rotation driving device, and the rotor (100) of permanent magnet array of the planar movement driving device is suspending above the stator (200) of coil array of the planar movement driving device under magnetic suspension; the angle measuring device (500) is positioned on the annular rotor (300) of permanent magnet array of the rotation driving device; the displacement measuring device includes PSD assemblies which includes receiving devices and transmitting devices, wherein the receiving devices are symmetrically fixed on the linear motors (600) around the stator (200) of coil array of the planar movement driving device, and the transmitting devices are symmetrically fixed around the rotor (100) of permanent magnet array of the planar movement driving device;
when the stator of coil array of the planar movement driving device is energized, a lorenthz force is generated between the stator (200) of coil array of the planar movement driving device and the rotor (100) of permanent magnet array of the planar movement driving device, such that the rotor (100) of permanent magnet array of the planar movement driving device generates pushing forces in the directions of an X axis, a Y axis and a Z axis; wherein the pushing forces along the X-axis and Y-axis directions in the horizontal plane enable the rotor (100) of permanent magnet array of the planar movement driving device to perform a planar movement in the X-Y plane and a rotation of a relatively small angle around the Z axis, the pushing force in the direction of the Z axis enables the suspension of the rotor (100) of permanent magnet array of the planar movement driving device, and a differential between the pushing forces of the Z-axis direction enables the rotor (100) of permanent magnet array of the planar movement driving device to rotate around the X and Y axes with a relatively small angle, thus achieving the movement of six degrees of freedom of the rotor (100) of permanent magnet array of the planar movement driving device; a torque due to lorenthz force is generated between the annular stator (400) of coil array of the rotation driving device and the annular rotor (300) of permanent magnet array of the rotation driving device, enabling the annular rotor (300) of permanent magnet array of the rotation driving device to perform a rotation of 360°, and further enabling the stator (200) of coil array of the planar movement driving device to perform a rotation of 360°, such that under the lorenthz force and the torque, the rotor (100) of permanent magnet array of the planar movement driving device can perform a rotation of 360° around the Z axis.

2. The maglev workpiece table with six degrees of freedom according to claim 1, characterized in that, in the rotation driving device, the permanent magnets of the annular rotor of permanent magnet array of the rotation driving device and the coils of the annular stator of coil array of the rotation driving device are all in the shape of rectangle, sector or trapezoid.

3. The maglev workpiece table with six degrees of freedom according to claim 1, characterized in that, in the planar movement driving device, the stator of coil array of the planar movement driving device is in a form of superimposed layers, wherein the adjacent two layers of coil array are in vertical directions with respect to each other.
